(19) United States
(12) Patent Application Publication
(10) Pub. No.: US 2010/0047618 A1
(43) Pub. Date: Feb. 25, 2010

(54) PRECIOUS METAL COMPOSITION, METHOD AND ARTICLE OF JEWELRY COMPRISING SAME

(75) Inventor: Ippolita Rostagno, New York, NY (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Seno Jewelry, LLC, New York, NY (US)

(21) Appl. No.: 12/195,659

(22) Filed: Aug. 21, 2008

(51) Int. Cl. B32B 15/01; C22C 5/06; B22D 23/00

(52) U.S. Cl. 428/669; 420/503; 164/75

(57) ABSTRACT

The present invention is related to a novel sterling silver compound for use in vermeil jewelry and other articles of manufacture. The compound includes an alloy composed of at least 92.5% by weight of silver, up to 7.5% by weight of gold, and the remainder in copper. The invention further relates to an article of jewelry including at least 92.5% by weight of silver, up to 7.5% by weight of gold, and the remainder in copper. The invention also relates to a method for making an article. The method includes providing a vessel and adding 3.75% by weight of gold, 94.0% by weight of silver, and 2.25% by weight of copper to the vessel. The method also includes melting the metals and mixing them until a homogenous mixture is formed. The method further includes pouring the homogenous mixture into a mold to form a semi-finished article and plating the semi-finished article with 18K rose gold.

### FIELD OF INVENTION

The present invention relates to a new composition for a precious metal and an article of jewelry comprising the same.

### BACKGROUND

Jewelry is often made from gold or other precious metals. In order to reduce cost and improve wear and durability, gold is often alloyed with other metals for use in jewelry. Metal alloys are homogeneous mixtures of two or more elemental metals. Alloys usually have different properties from those of the component elements.

By alloying one metal with others the metal's properties are often enhanced. For example, pure gold 24 carat (24K) is very soft and is usually alloyed with base metals, e.g. copper, for use in jewelry, altering its hardness and ductility, melting point, color and other properties. This change in physical properties is sometimes due to the sizes of the atoms in the alloy, since larger atoms exert a compressive force on neighboring atoms, and smaller atoms exert a tensile force on their neighbors, helping the alloy resist deformation. Alloys may exhibit marked differences in behavior even when small amounts of one element occur.

Such alloys require a low melting point in order to be worked properly. The metal must have sufficiently low melting point while maintaining its malleability and ductility. Often, jewelry is made of silver or an alloy thereof, and is later coated with gold.

Gold plated jewelry is generally made up of silver as a base metal which is shaped and then coated with gold. The gold acts as a barrier metal to help reduce tarnishing which is common for silver jewelry. Normally, silver is covered with layers of copper, nickel and eventually gold. The layer of gold is often very thin in order to reduce production costs. Many jewelry designers, in order to reduce costs, alloy the base metal (silver) with other metals, e.g., nickel, copper, manganese, etc. Gold plating is used in the jewelry arts, namely silver is plated with gold, however, often in order to minimize cost, silver is mixed with copper, which can eventually diffuse into the gold layer that plates it, causing gradual fading of the color and tarnishing of the surface. Nickel is often used as what is known as a barrier metal layer which is used to coat the silver/copper mixture prior to plating with gold. Copper is often used to cover silver which is then in turn covered with nickel and then eventually plated with gold. With time the gold layer will wear revealing the nickel layer beneath it. Many individuals have sensitivity to nickel and develop contact dermatitis from prolonged exposure to the nickel.

Vermeil, sometimes called silver gilt, is generally sterling silver plated or coated with gold. The standard for silver to be considered sterling is silver having a minimum millesimal fineness of 925. Sterling is an alloy of silver containing 92.5% pure silver and 7.5% other metals, usually copper.

Vermeil jewelry is a popular form of jewelry since it has the appearance of solid gold jewelry at a greatly reduced price. Under the Federal Trade Commission Guidelines (§23.5), to be considered vermeil, the product's base metal must be sterling silver and the gold layer must be at least 10 carat (10K) (42%) and be at least 2.5 micrometers thick. Sterling silver covered with another metal cannot be called vermeil. A typical example of vermeil is sterling silver coated with 14 carat (14K) (58%) gold.

Jewelry designers are producing more vermeil jewelry in order to appeal to consumers who would not normally purchase solid gold designer jewelry items.

### SUMMARY

The present invention is related to a novel sterling silver compound for use in vermeil jewelry and other articles of manufacture. The compound includes an alloy which is composed of at least 92.5% by weight of silver, up to 7.5% by weight of gold, and the remainder in copper.

The invention is also related to a method for making a sterling silver alloy. The method includes providing a vessel and adding 3.75% by weight of gold, 94.0% by weight of silver, and 2.25% by weight of copper to the vessel. The method further includes melting the metals and mixing the melted metals until a homogenous mixture is formed.

The invention further relates to an article of jewelry including at least 92.5% by weight of silver, up to 7.5% by weight of gold, and the remainder in copper.

The invention still further relates to a method for making an article. The method includes providing a vessel and adding 3.75% by weight of gold, 94.0% by weight of silver, and 2.25% by weight of copper to the vessel. The method also includes melting the metals and mixing them until a homogenous mixture is formed. The method further includes pouring the homogenous mixture into a mold to form a semi-finished article and plating the semi-finished article with 18 carat (18K) rose gold.

### DETAILED DESCRIPTION OF THE PREFERRED EMBODIMENTS

The present invention is related to a novel alloy containing gold, silver and copper. The gold used is preferably 18K (0.750) but can be 20-24K depending on the desired use. The alloy is ultimately plated with pink or rose gold after casting.

In order to provide a wider selection to consumers, vermeil jewelry is produced which is sterling silver coated with some form of gold, generally 14K (58%) gold. In order for a combination to be considered vermeil, the gold must be a minimum of 10K (42%) and at least 2.5 micrometers thick. Vermeil jewelry provides consumers with a piece of sterling silver jewelry that has the outward appearance of a solid gold piece at a substantially lower price.

Rose gold, also known as pink gold, or red gold, is an alloy of gold and copper which is used in specialized jewelry since it has a reddish-pink hue. In rose gold the red color is imparted from copper. A higher copper content will generally result in a redder coloration of the finished product. Rose gold is an alloy and therefore does not have a pure component, such as 24K gold. A common alloy of rose gold is 18K (i.e., 75% gold, and 25% copper by mass).

The sterling silver compound of the present invention is an alloy containing at least 92.5% by weight of silver, up to 7.5% by weight of 18K gold and the remainder in copper. The silver used in the alloy is 100% pure silver. The gold used is generally 18K gold but can alternatively be 20-24K. Preferably, the sterling silver compound of the present invention contains 94% silver, 3.75% 18K gold and 2.25% copper.

The metals are added to a ceramic or a zirconium vessel or cylinder or crucible and heated to approximately 1985° F. at atmospheric pressure. Silver's melting point is 1763.2° F.; 18K gold has a melting point of 1675° F. and copper's melting point is 1984.32° F. The alloy is mixed for one to two minutes after melting and is then cast. The alloy can be poured into ingot molds for later use or molded in to an article (e.g. jewelry, sculpture, etc.) using a known technique such as lost-wax casting.

The resulting alloy has a slight rose gold colored tint due to the copper and gold in the alloy. Once the article is cast and finished, it is plated with 18K rose gold. The article is electroplated, in a conventional manner, in an electro-plating tank containing a solution of potassium gold cyanide, KAu(CN)₂ and liquid catalysts. It is a feature of the present invention that the gold used in the solution is 18K rose gold.

The article is electrolyzed until a coating layer of 18K rose gold having a thickness of at least 3 micrometers (μ) is formed. After the plating is carried out, the thickness of the plating is verified by x-ray spectrography. The article formed is usually a piece of jewelry but can also be, for example, a watch case, a statue, a mobile, a frame, flatware, an ingot, etc.

The article formed is a vermeil having a rose-gold finish with the advantage of having better wear as a result of the gold in the base metal. It has been discovered that since the base metal of the present invention includes gold, the diffusion of the copper, in the base metal, into the plating gold layer is reduced. This results in a reduction of the gradual fading of the color and tarnishing of the plating gold layer.

The alloy of the present invention can also be used in other industries where luster or shine is desired, for example, in sculptures, in housewares, and in flatware. Furthermore, due to the excellent conductivity properties of gold, the alloy of the present invention can be used as a conductor for electronics.

What is claimed is:

1. A sterling silver alloy comprising at least 92.5% by weight of silver, up to 7.5% by weight of gold, and the remainder in copper.

2. The alloy of claim 1, wherein the amount of gold is between 2 and 4% by weight.

3. The alloy of claim 1, wherein the amount of gold is between 3.5 and 3.75% by weight.

4. The alloy of claim 1, wherein the percentage of silver is between 92 and 95% by weight.

5. The alloy of claim 1, wherein the amount of gold is 3.75% and the amount of silver is 94%.

6. The alloy of claim 1, wherein the gold is 18K gold.

7. A method for making a sterling silver alloy, the method comprising providing a vessel; adding 3.75% by weight of gold, 94.0% by weight of silver, and 2.25% by weight of copper to the vessel; melting the metals; and mixing the melted metals until a homogenous mixture is formed.

8. An article of jewelry comprising the alloy of claim 1.

9. The article of jewelry of claim 8, further comprising a rose gold plating.

10. The article of jewelry of claim 9, wherein the rose gold plating is at least 2.5 μ thick.

11. A method for making an article, the method comprising providing a vessel; adding 3.75% by weight of gold, 94.0% by weight of silver, and 2.25% by weight of copper to the vessel; melting the metals; mixing the melted metals until a homogenous mixture is formed; pouring the homogenous mixture into a mold to form a semi-finished article; and plating the semi-finished article with 18K rose gold.

12. The method of claim 11, wherein the article is an item of jewelry.

13. The method of claim 11, wherein the article is selected from the group consisting of: jewelry, watch casings, statuary, mobiles, frames, flatware and ingots.
